(19) United States
(12) Patent Application Publication
(10) Pub. No.: US 2001/0002777 A1
(43) Pub. Date: Jun. 7, 2001

(54) Single phase autonomous generator with DC excitation

(76) Inventors: Raul Ravinovici, Beer-Sheva (IL); Nathan Ben-Hail, Beer-Sheva (IL)

Correspondence Address: Altera Law Group, LLC, Suite 100, 6500 City West Parkway, Minneapolis, MN, 55344-7701, US

(21) Appl. No.: 09/725,647

(22) Filed: Nov. 29, 2000

(30) Foreign Application Priority Data
Dec. 2, 1999 (IL) 133278

(51) Int. Cl. H02K 17/42; H02K 19/20; H02K 19/24

(52) U.S. Cl. 310/166; 310/168; 310/171

(57) ABSTRACT

The invention relates to a single-phase autonomous machine, which comprises: A P-pole pairs rotor, a P-pole pairs stator which comprises two windings, an excitation winding and a single-phase power winding; and an external source for providing current to the said excitation winding, for, creating a magnetic field that interacts with a time-varying inductance caused by the rotor rotation.

### FIELD OF THE INVENTION

The field of the present invention relates to power generators. More particularly, the invention relates to DC excitation means for induction and reluctance generators.

### BACKGROUND OF THE INVENTION

Induction generators (hereinafter “IG”) and reluctance generators (hereinafter “RG”) are well known and are widely used for a variety of purposes- For example, such generators are used i cars, in the aerospace industry, in wind turbines, etc.

Induction and reluctance generators have long been known as electrical appliances and embodied in several forms However, the prior art generators of these types suffer from several drawbacks. In both of these types of generators, capacitors are required in parallel to the output power windings in order to allow autonomous work. These capacitors force a very narrow bandwidth for the mechanical working speed. Working out of the narrow speed bandwidth involves the provision of essentially no output power. Therefore, severe stability problems an-se when the load increases

Other types of autonomous generators, such as DC generators and synchronous generators, need brushes and slip-rings for transferring electric current from the stator's windings to the rotor's windings or viceversa for excitation. This type of mechanical structure suffers from the major disadvantage that the brushes tend to tear after a relatively short time, due to friction and mechanic vibrations. Their replacement, when necessary, involves a significant inconvenience.

A brushless excitation for permanent magnets synchronous generators is also available. However, this type of excitation suffers from the threatof a possible demagnetization of the permanent magnets in the event of a malfunction, such as a short circuit. In such a case, the repair is expensive, and also involves a significant inconvenience.

Furthermore, in many applications, generators have to supply a relatively stable output voltage, in a wide range of motor rotation speed. Many generators fail to provide a stable output voltage, particularly at low speeds of the rotor rotation.

Williamson et. al, “Generalised Theory of the Brushless Doubly-Fed Machine, Part 1: Analysis” discloses a BDMFM induction machine. The machine comprises a cage-type rotor. However, the said machine suffers particularly from the drawbacks that the number of the pole pairs in the rotor and the stator is not the same.

It is therefore an object of the present invention to overcome all the above drawbacks.

It is another object of the invention to provide a method for DC excitation of an autonomous generator. More particularly, the method is preferably suitable in a reluctance-type generator CRG) and in an induction generator (IG).

It is still another object of the invention to increase reliability, and to reduce maintenance. More particularly, it is an object of the invention to provide brushless IG and RG type machines, eliminating the need for replacement of brushes and/or slip-rings.

It is another object of the present invention to provide an IG and an RG, which are simpler in structure, of lower cost, and efficient. More particularly, an object of the invention is to provide induction and reluctance-type generators in which both the rotor and stator are one-phase, and have the same number of poles, Moreover, all the windings in the stator are also of the same number of poles as in the rotor.

It is still another object of the invention to provide a DC-excited machine that can supply an output voltage of a relatively high frequency even in low-speed rotor rotation.

It is still another object of the invention to provide a brushless, DC-excited IG and RG type machine, that can operate with no capacitors in parallel to the output power winding.

Other advantages and objects of the invention will become apparent as the description proceeds.

### SUMMARY OF THE INVENTION

The present invention relates to a single-phase autonomous machine that comprises, a P-pole pairs rotor, a P-pole pairs stator comprising two windings, an excitation winding and a single-phase power winding, and an external source for providing a current to the said excitation winding. The autonomous machine of the invention is characterized in that the current in the excitation winding creates a magnetic field that interacts with a time-varying inductance caused by the rotor rotation, and in that the number of poles in the stator and rotor is the same. The power winding is used for delivering an output one-phase AC voltage, and it is preferably in quadrature to the excitation winding.

According to one embodiment of the invention the machine is a generator. According to another embodiment of the invention the machine is a motor.

The current provided to the excitation winding is preferably a DC current Alternatively, the current provided to the excitation welding may be an AC current.

According to one embodiment of the invention the generator is an induction generator with a short-circuited single-phase rotor winding. In other case, the rotor may comprise a plurality of embedded individual loop-ring windings. The individual loop-ring windings may be made of copper, aluminum, or another electrical conducting material.

According to still another embodiment of the invention the rotor and/or the stator windings are made of a superconductive material.

According to another embodiment of the invention the generator is a reluctance generator. In that case, the rotor core is preferably made of a ferromagnetic material. According to one embodiment of the invention, the stator windings of the reluctance generator are made of copper, aluminum, or another electrical conducting material.

According to one embodiment of the invention, the frequency of the output AC voltage is twice the frequency of the rotor rotation.

The invention further relates to a method for generating a single-phase AC voltage, comprising: (a) providing a generator with a rotor and stator; e) providing a stator with two windings, a power winding and an excitation winding preferably in quadrature with respect to one another; and (c) providing a current to the excitation winding of the stator, thereby causing the rotation of the rotor.

The machine of the invention with any of the structures as described above can also operate as an electric motor.

### BRIEF DESCRIPTION OF THE DRAWINGS

FIG. 1 shows the structure of a DC-excited RG according to one embodiment of the invention;

FIG. 2 shows an equivalent circuit of the DC-excited RG of FIG. 1 and of the DC excited IG of FIG. 3;

FIG. 3 shows the structure of a DC-excited IG according to one embodiment of the invention;

FIG. 4a is an experimental plot showing the stator power winding voltage versus the rotor speed in a DC-excited RG according to one embodiment of the invention. FIG. 4b is an experimental plot showing the stator power winding voltage versus the rotor speed in a DC-excited IG according to another embodiment of the invention;

FIG. 5 is an experimental plot showing the maximum power of a DC-excited IG versus the rotor speed according to one embodiment of the invention;

FIG. 6 shows the circuit of a DC-excited RG with a capacitor in series with the load;

FIGS. 7a-7d show experimental results of the power winding voltage waveforms a DC-excited RG according to one embodiment of the invention. FIG. 7a relates to a no load, no capacitor case, FIG. 7b to a 30 Ωload, no capacitor case, FIG. 7c to a 15 Ω load, no capacitor case, and FIG. 7d to a 30 Ω load, 15 μF capacitor case;

FIGS. 8a-8d show experimental results of the power winding voltage waveforms in a DC-excited IG according to one embodiment of the invention. FIG. 8a relates to a no load, no capacitor case, FIG. 8b to a 30 Ω load, no capacitor case, FIG. 8c to a 15 Ω load, no capacitor case, and FIG. 8d to a 30 Ω load, 15 μF capacitor case; and

FIG. 9 Shows the structure of a single-phase rotor with loops of copper for an IG according to one embodiment of the invention, such as the one shown in FIG. 3.

### DETAILED DESCRIPTION OF PREFERRED EMBODIMENTS

The present application particularly relates to single-phase reluctance and induction generators which are provided with a DC excitation, eliminating the need for using brushes, slip-rings, rings, or capacitors in parallel to the output power winding for autonomous operation. In both of the reluctance and the induction generators of the invention, the number of poles in the stator and the rotor can be the same, while an generators of the prior art, the number of poles in the rotor and the stator must be different. Therefore, the structure of the generators according to the invention is significantly simpler in comparison with similar generators of the prior art.

More particularly, according to a preferred embodiment of the invention, a DC excitation winding is provided in the stator of the autonomous generator. Moreover, the number of poles in the power winding and in the excitation winding on the stator is also the same.

The DC excitation winding carries a DC current that creates a magnetic field. The magnetic field that is created by said DC current flowing in the excitation winding of the stator interacts with a time-varying inductance caused by the rotor rotation, causing an induced EMF in the power windings of the stator.

DO excitation is common in wound rotor synchronous generators. However, in such a type of generator, the use of brushes and slip-rings is required.

The invention, however, includes means for providing a DC excitation to an IG and an RG which, according to the invention, are brushless, in similarity to permanent magnet synchronous generators.

The frequency of the generated output voltage of the DC excited IG or RG, according to a preferred embodiment of the invention, is twice the rotation speed of the rotor, multiplied by the number of pole pairs. This is a valuable characteristic, particularly in applications utilizing low rotor speeds, such as wind turbines for energy conversion or car generators.

The autonomous generators with DC excitation according to the invention provide a relatively stable output voltage, even when the rotor speed significantly varies. The stabilizing of the output voltage is obtained by controlling the DC current in the excitation winding. The means for controlling the DC current in the excitation winding are generally much simpler when compared with the voltage stabilizing means commonly used in the prior art autonomous generators.

Furthermore, the DC, brushless IG and RG of the invention do not require capacitors in parallel to the output winding in order to generate an electric power, although use of such a capacitor can be advantageous, in some cases.

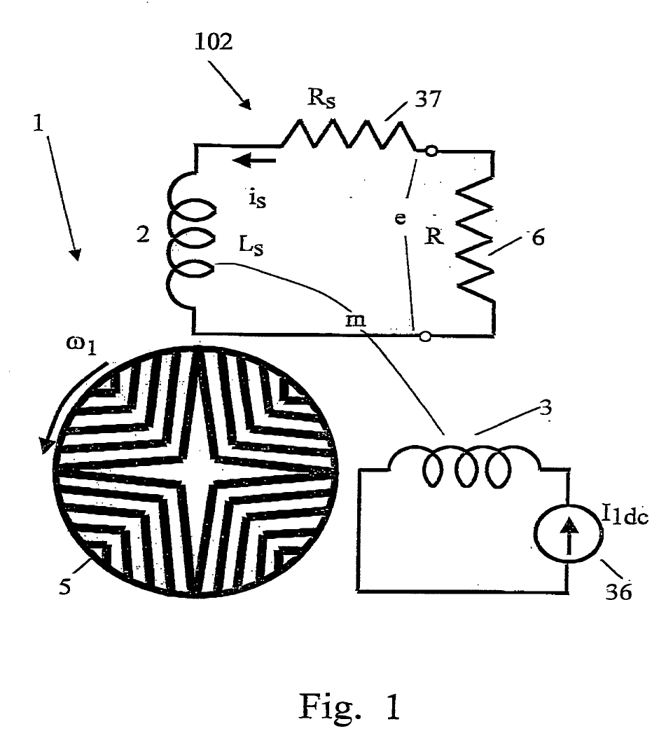

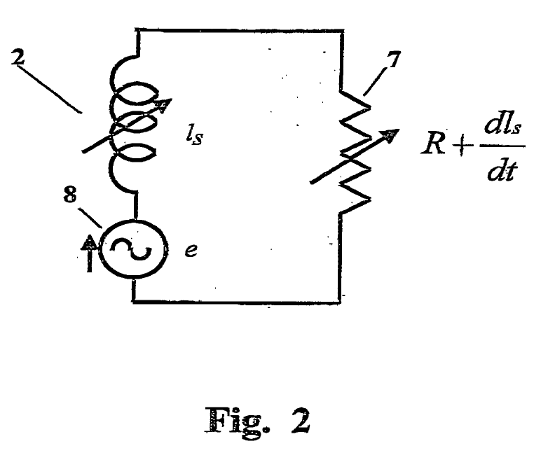

FIG. 1 shows a single-phase RG according to one embodiment of the invention. FIG. 2 shows an equivalent circuit of the said DC-excited RG. The stator of the reluctance generator 1 comprises a set of power windings 102 consisting an internal winding Lₛ 2 and its internal resistance Rₛ 37, and an excitation winding 3. The said power and excitation windings, 102 and 3 respectively, of the stator are wound in quadrature. A DC source 36 provides a DC current I_{1dc} to the excitation winding 3 that creates a magnetic field.

The rotor 5 of the RG of FIG. 1 may be, for example, an axially laminated anisotropic rotor with salient poles, while forms of salient pole rotors may also be used. The rotor shown in FIG. 1 has four poles, however, the rotor may have a different number of poles, identical to the number of poles in the stator. Assuming that the rotor 5 of the RG 1 rotates at a constant mechanical speed ω₁, and has P pole pairs, it can be shown that the angular frequency ωₐ of the generated voltage at the power winding 2 is: ωₐ=2Pω, or ωₐ=2ωᵣ, where ωᵣ=Pω is the electrical speed of the rotor.

A magnetic field is created by the current flowing through the excitation winding and interacts by means of the time-varying mutual inductance m between the power winding 102 consisting of inductance Lₛ and its internal resistance Rₛ 37, and the excitation winding 3 to induce an EMF e, in the power winding 102. The pulsating mutual inductance m varies in a sinusoidal manner around its average value M.

More particularly,

m=M(1−ksin(2ωrt)) (1)

where:

$$\begin{matrix}k = \frac{{M}_{m a x} - {M}_{m i n}}{{M}_{m a x} - {M}_{m i n}} < 1 \\ = \frac{{M}_{m a x} + {M}_{ m i n}}{2}\end{matrix} \qquad ( 2 )$$

For obtaining the EMF, (Idcm) is derivated. Then:

e=−21_{dc}kMω, cos(2ωᵣt)

E=\sqrt{2I}_{dc}kMω, (3)

The induced EMF e, is therefore proportional to the rotor speed and to the rotor asymmetry that is represented by k.

The resistance 6 shown connected to the power windings 102 is the load of the RG and the resistance 37 is the resistance of the stator's power winding 102. It can also be shown that the instantaneous inductance lₛ of the powez winding 2 is also time-varying:

Lₛ=Lₛ(1−kcos(2ωrt)) (4)

wherein Lₛ is the average inductance of the power winding. The saliency index k, given by (2), depends on the rotor structure.

For the principle explanation, the RG loss can be neglected. Then the mathematical model of the RG is obtained:

$$\frac{ⅆ ( {l}_{s} {l}_{s} )}{ⅆ t} + {Rl}_{s} = e \\ or \\ {l}_{s} \frac{ⅆ {l}_{s}}{ⅆ t} + [ R + \frac{ⅆ {l}_{s}}{ⅆ t} ] {l}_{s} = e \qquad ( 5 )$$

Wherein iₛ is the current in the stator power winding 102. Equation (5) is therefore a mathematical model of an RL circuit supplying an EMF e 8, where both the inductance lₛ 2 of the power winding 102 and the equivalent resistance 7

$$( R + \frac{ⅆ {l}_{s}}{ⅆ t} )$$

are time-varying as shown in FIG. 2.

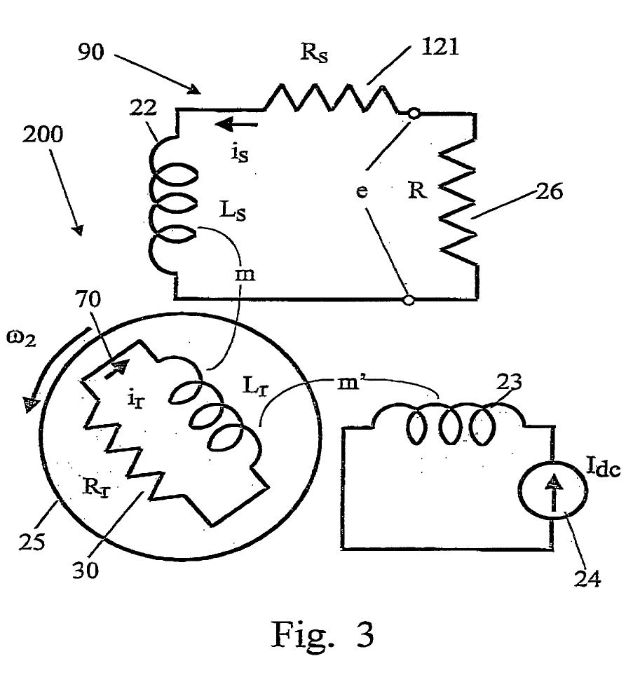

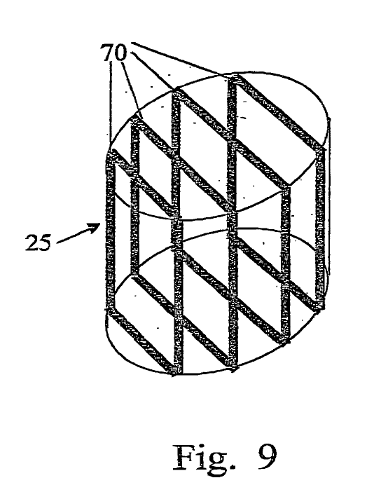

FIG. 3 shows a DC-excited IG with a single-phase cylindrical rotor 25. As shown in FIG. 9, the rotor 25 of the IG according to a preferred embodiment of the invention has a special structure, different from a conventional IG rotor. The rotor 25 comprises a plurality of individual loop-windings 70 that are embedded within the body of the rotor as principally shown in FIG. 9. FIG. 9 shows particularly the structure of the loop windings within the rotor. The body of the rotor may have any suitable conventional shape, as needed. Unlike a conventional IG rotor in which the rotor windings have a cage structure, in the rotor of the invention there is no electric connection between the individual loop-windings 70.

The stator power winding 90 consists of inductance Lₛ 22 and its internal resistance Rₛ 121. The load is indicated as R 26.

Assuming that the rotor 26 of the IG rotates at a constant angular speed ω₂, and assuming that the IG has P pole pairs, the electrical angular speed of the rotor is ωᵣ=Pω₂. The IG, when loaded by the resistor R indicated as numeral 26 has the following mathematical model:

$$\begin{matrix}{L}_{s} \frac{ⅆ {i}_{s}}{ⅆ t} + \frac{ⅆ ( {mi}_{r} )}{ⅆ t} + {Ri}_{s} = 0 & ( 6 ) \\ {L}_{r} \frac{ⅆ {i}_{r}}{ⅆ t} + \frac{ⅆ ( {mi}_{s} )}{ⅆ t} + {I}_{d c} \frac{ⅆ {m}^{′}}{ⅆ t} + {R}_{r} {i}_{r} = 0 & ( 7 )\end{matrix}$$

wherein, iₛ is the current in the stator power winding 90, iᵣ is the current in the rotor winding 70, I_{dc} 24 is DC current in the stator excitation winding 23, Lₛ is the stator power winding 90 inductance, Lᵣ is the rotor windings' 70 inductance, m is the mutual inductance between the power winding 90 and the rotor windings 70, and m' is the mutual inductance between the excitation winding 23 and the rotor windings 70. The power wining 90 and the excitation winding 23 of the stator are in quadrature. If the stator and the rotor windings are sinusoidally distributed, the change of the mutual inductance with respect to the rotation angle is also sinusoidal, as shown e.g., P. Vas, Electrical Machines and Drives, Clarendon Press, Oxford, 1992, then, the mutual inductances are given by:

m=M cos(ωrt) (8)

m′=M sin(ωrt)

Equations (6) and (7) could be solved, for example, by numerical methods. A further insight into the IG behavior of the invention could be obtained by assuming that the rotor winding resistance 30 (Rᵣ) is negligible. This supposition is supported by practical and constructive considerations related to the machine efficiency, but also by experimental results as hereinafter shown. Therefore, supposing that Rᵣ=0, the following expression is obtained from (6-8):

$${l}_{s} \frac{ⅆ {i}_{s}}{ⅆ t} + ( R + \frac{ⅆ {l}_{s}}{ⅆ t} ) {i}_{s} = e \qquad ( 9 )$$

wherein

$$\begin{matrix}\begin{matrix}{M}^{2} \approx {L}_{s} {L}_{r} \\ {l}_{s} = \frac{{L}_{s}}{2} [ 1 - cos ( 2 {ω}_{r} t ) ]\end{matrix} & ( 10 ) \\ \begin{matrix}e = {I}_{d c} {L}_{s} {ω}_{r} cos ( 2 {ω}_{r} t ) \\ E = \frac{{I}_{d c} {L}_{s} {ω}_{r}}{\sqrt{2}}\end{matrix} & ( 11 )\end{matrix}$$

Equation (9) relating to the IG 200 of the invention resembles equation (5) relating to the RG 1 of the invention. More particularly it exemplifies that a single-phase rotor induction generator is a special case of a more general class of reluctance generators, that comprises also the RG itself.

### EXPERIMENTAL RESULTS

In order to demonstrate the applicability of the invention, the following experiments where made:

A three-phase four-poles ALA (axially laminated anisotropic) reluctance machine (0.15 hp) and a three-phase four-poles slip ring induction machine (1.5 hp) where used in order to verify the theoretical results. The machines have been operated in a single-phase mode. One of the stator phases served as a power winding, and another stator phase winding was used as the DC excitation winding. The π/3 spatial angle between the windings provided only a phase shift effect on the analytical results.

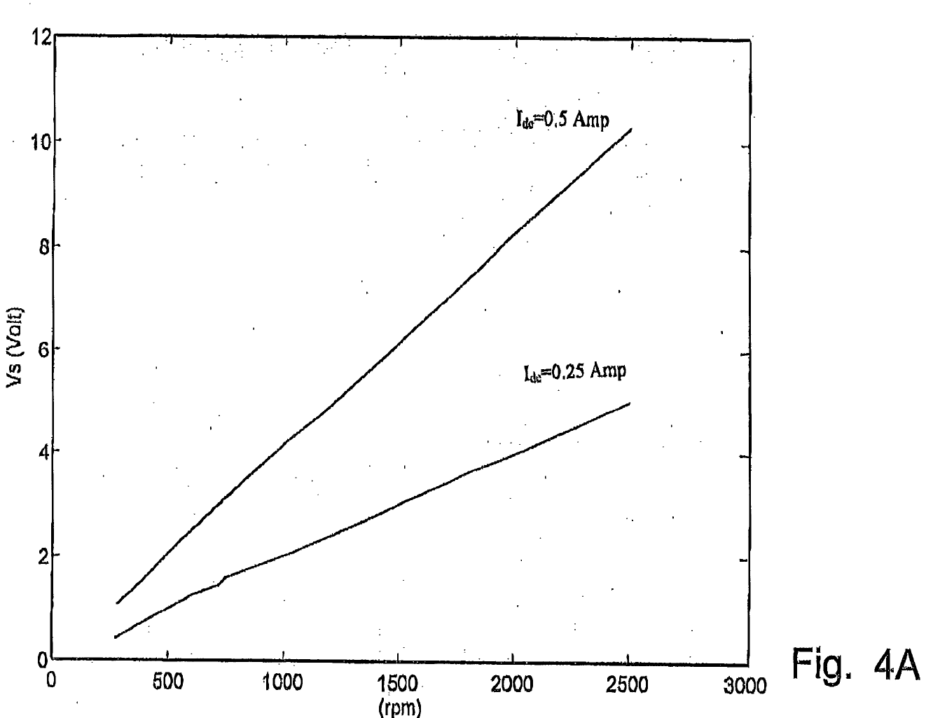

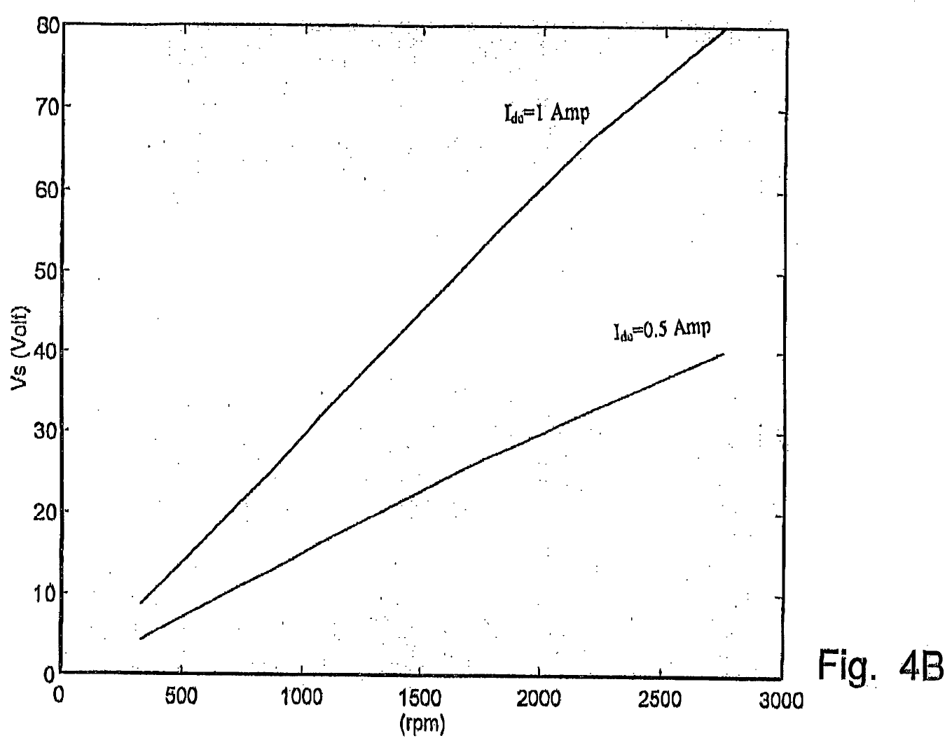

The EMF has been measured at the terminals of the open circuit power winding of the RG and the IG. Due to the similar behavior of the machines, the following discussion is valuable for both the IG and RG cases. As shown in FIGS. 4a (for RG) and 4b (for IG), the measured EMF has been confirmed being linearly related to the rotor speed and to the DC excitation current. Furthermore, the maximum power supplied to the load has also been found linearly related to the rotor speed. This can be explained theoretically by analyzing the circuit for its first harmonic. This approximation treats lₛ as a constant inductance. Then:

$$P = \frac{{E}^{2} R}{{R}^{2} + {( 2 {ω}_{r} L )}^{2}} \qquad ( 12 )$$

E is the EMF, P is the output power, ωᵣ is the rotor electrical speed, L is the average power winding inductance. The power winding resistance Rₛ is neglected in both cases.

The maximum power Pₘₐₓ is supplied to the load when R=ωrL. Hence:

$$\begin{matrix}{P}_{m a x} = \frac{{( kM )}^{2}}{{L}_{s}} {I}_{d c}^{2} {ω}_{r} & For IG \\ {P}_{m a x} = \frac{{L}_{s}}{4} {I}_{d c}^{2} {ω}_{r} & For RG\end{matrix} \qquad ( 13 )$$

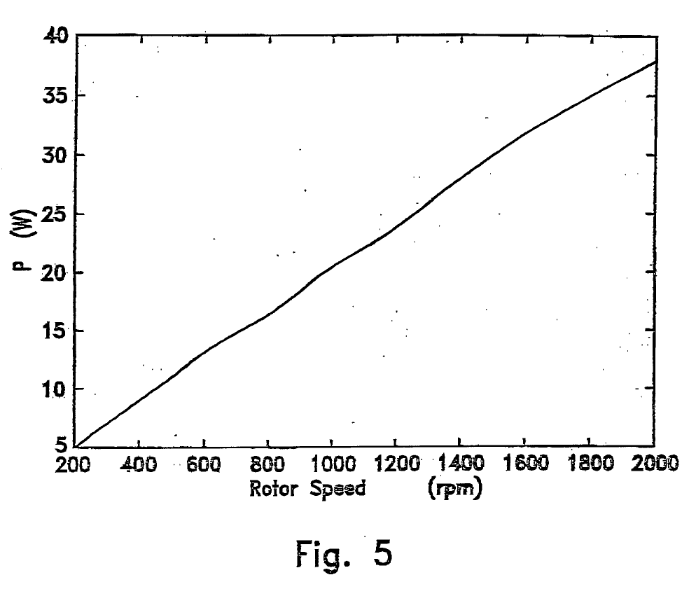

FIG. 5 shows the measured dependency of the maximum power versus the generator speed as measured. The load resistance was changed from time to time in order to fit the maximum output power desired.

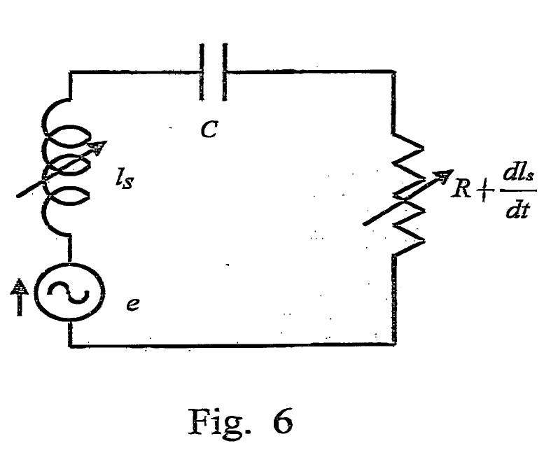

A capacitor C can be added in series to the power winding in order to compensate the power winding inductance, as shown in FIG. 6. This is similar to the case of an induction motor that is supplied through a capacitor-compensated feeder, such as shown in P. Vas, Electrical Machines and Drives, pages 464-472, Clarendon Press, Oxford, 1992. Then, the output power in both, cases is given by:

$$P = \frac{{E}^{2} R}{{( R + {R}_{s} )}^{2} + {( 2 {ω}_{r} L - \frac{1}{2 {ω}_{r} C} )}^{2}} \qquad ( 14 )$$

wherein Rₛ is the power winding resistance.

Maximum power at resonance is obtained when R=Rₛ. Therefore:

$${P}_{m a x} = \frac{{E}^{2}}{4 {R}_{s}} \qquad ( 15 )$$

In the latter case, an increased Pₘₐₓ can be obtained by reducing the generator loss. Furthermore, Pₘₐₓ varies by the square of the rotor speed rather than linearly.

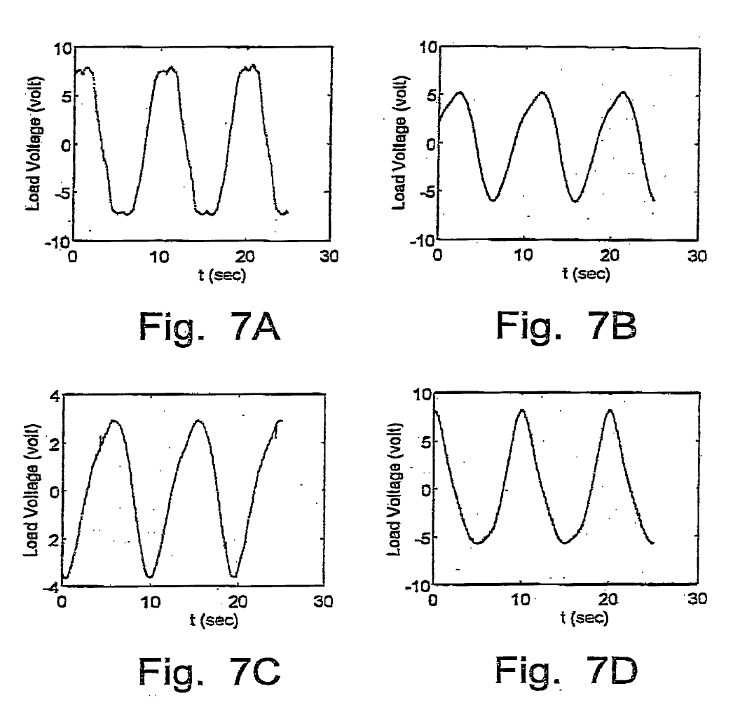

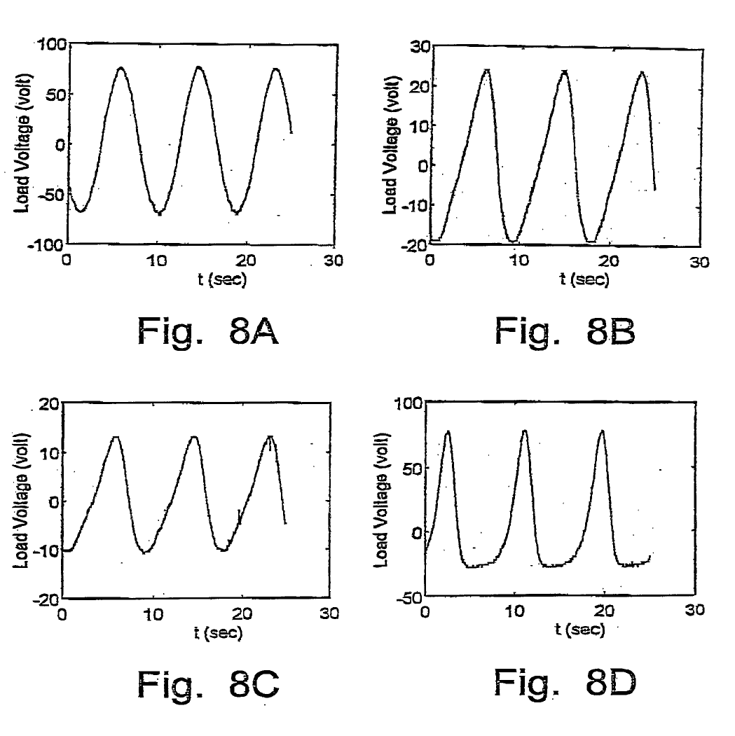

Equations (12) and (14) are derived by taking into account only the first harmonic of the generated voltages. They signify, however, the main characteristics of the IG and RG generators of the invention. However, it should be noted that an accurate current waveform of the generators has been found to contain a strong second harmonic, as shown in the waves of FIGS. 7 and 8. FIGS. 7a to 7d show experimental results of the output power winding voltage waveforms of a DC-excited RG. FIG. 7a relates to an experiment with no load, no capacitor at the power winding, FIG. 7b to a 30 Ω load no capacitor at the power winding, FIG. 7c to 15 Ω load, no capacitor at the output power winding, and FIG. 7d to an experiment with 30 Ω load 50 μF capacitor at the output of the power winding of the DC excited RG. FIGS. 8a to 8g show experimental results of the output power winding voltage waveforms of a DC excited IG. FIG. 8a relates to an experiment with no load, no capacitor at the output power winding, FIG. 7b to a 30 Ω load no capacitor at the output power winding, FIG. 7c to 15 Ω load, no capacitor at the output power winding, and FIG. 7d to an experiment with 30 Ω load 50 μF capacitor at the output power winding of the DC excited IG.

As shown, the more the generator is loaded, the more the current waveform is distorted. The reason for this is that the rate of change of the power winding inductance has a greater effect in the equivalent resistance expression

$$( R + \frac{ⅆ {l}_{s}}{ⅆ t} )$$

when the load resistance R is small.

Therefore, it has been shown by the present invention that the common reluctance machine can be seen as a special case of a more general class of electric machines that possess an asymmetry in their magnetic or electric circuit. The asymmetry can be expressed as the ratio Ld/Lq wherein Ld is the maximum self inductance of the output power winding, and Lq is the minimum self inductance of the output power winding. This asymmetry can be obtained by either an iron asymmetry (in a conventional reluctance machine) or by a winding asymmetry (in an induction machine) or by both. It has been shown that similar mathematical equations govern both an RG and a single-phase rotor IG.

In the case of an IG, the rotor windings should have a number of poles equal to that of the stator power winding and of the excitation winding. Furthermore, according to one embodiment of the invention, the rotor winding is a short-circuited single-phase winding. Such short-circuited single-phase winding is common in the art. Alternatively, the rotor winding may consist of a low-resistance copper, aluminum, or another electrical conducting material rings as shown in FIG. 9.

The DC excitation eliminates the need for a capacitor as a necessary component for autonomous power generation, and the need for brushes. The generated power varies by the square of the excitation current. That is, by increasing the excitation current, high power is generated even at a low rotor speed.

The use of DC excitation in accordance with the generator of the invention is preferable. However, the IG and the RG generators can also be excited by an AC excitation in same generator structures as described above.

It should be noted herein the IG and RG of the invention are only specific examples for induction and reluctance machines. As is known in the art, the said machines can be easily modified to correspondingly operate as an inductance or a reluctance motor.

According to still another embodiment of the invention, superconductive materials can also be utilized in the reluctance and induction machines of the invention for further reducing the winding losses at high current values. The induction generator is especially advantageous as a superconductive generator, as in high excitation currents, the iron permeability decrease and power could be generated without resorting to an iron core asymmetry, as in the case of a reluctance machine.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A single-phase autonomous machine comprising:
a. A P-pole pairs rotor;
b. A P-pole pairs stator comprising two windings, an excitation winding and a single-phase power winding;
c. External source for providing current to the said excitation winding, for creating a magnetic field that interacts with a time-varying inductance caused by the rotor rotation;

2. A machine according to claim 1, wherein the machine is a generator.

3. A machine according to claim 1, wherein the machine is a motor.

4. A machine according to claim 1, wherein the current provided to the excitation winding is a DC current.

5. A machine according to claim 1, wherein the current provided to the excitation winding is an AC current.

6. A machine according to claim 2, wherein the power winding outputs one-phase AC voltage.

7. A machine according to claim 2, wherein the power winding is in quadrature to the excitation winding.

8. A machine according to claim 2, wherein the generator is an induction generator with a short-circuited single-phase rotor winding.

9. A machine according to claim 8, wherein the rotor comprises a plurality of individual loop-ring windings embedded in the body of the rotor.

10. A machine according to claim 9, wherein the individual loop-ring windings are made of copper, aluminum, or another electrical conducting material.

11. A machine according to claim 9, wherein the rotor and stator windings are made of a superconductive material.

12. A machine according to claim 2, wherein the generator is a reluctance generator.

13. A machine according to claim 12, wherein the core of the rotor is made of a ferromagnetic material.

14. A machine according to claim 12, wherein the stator windings are made of a superconductive material.

15. An autonomous generator according to claim 2, wherein the frequency of the output AC voltage is twice the frequency of the rotor rotation.

16. A method for generating a single-phase AC voltage, comprising:
a. Providing a generator with a P-pole pairs rotor and a P-pole pairs stator;
b. Providing in the stator two windings, a power winding and an excitation winding;
c. Providing a current to the excitation winding of the stator.

17. A method according to claim 16, wherein the power winding is in quadrature with respect to the excitation winding.

18. An autonomous machine according to claim 1, wherein the machine is an electric motor.

19. A machine according to claim 3, wherein the power winding used for inputting one-phase AC voltage.

20. A machine according to claim 3, wherein the power winding is in quadrature with respect to the excitation winding.

21. A machine according to claim 3, wherein the motor is an induction motor with a short-circuited single-phase rotor winding.

22. A machine according to claim 3, wherein the rotor comprises a plurality of individual loop-ring windings which are embedded in the body of the rotor.

23. A machine according to claim 22, wherein the individual loop-ring windings are made of copper, aluminum, or another electrical conducting material.

24. A machine according to claim 3, wherein the rotor and/or the stator windings are made of a superconductive material.

25. A machine according to claim 3, wherein the motor is a reluctance motor.

26. A machine according to claim 25, wherein the rotor core is made of a ferromagnetic material.

27. A machine according to claim 25, wherein the stator windings are made of a superconductive material.

28. A machine according to claim 2, wherein the rotor and/or the stator windings are made of a superconductive material.
